(19) United States
(12) Patent Application Publication
(10) Pub. No.: US 2015/0364127 A1
(43) Pub. Date: Dec. 17, 2015

(54) ADVANCED RECURRENT NEURAL NETWORK BASED LETTER-TO-SOUND

(71) Applicant: Microsoft Corporation, Redmond, WA (US)

(72) Inventors: Pei Zhao, Beijing (CN); Kaisheng Yao, Newcastle, WA (US); Max Leung, Beijing (CN); Mei-Yuh Hwang, Bellevue, WA (US); Sheng Zhao, Beijing (CN); Bo Yan, Union City, CA (US); Geoffrey Zweig, Sammamish, WA (US); Fileno A. Alleva, Redmond, WA (US)

(73) Assignee: MICROSOFT CORPORATION, Redmond, WA (US)

(21) Appl. No.: 14/303,934

(22) Filed: Jun. 13, 2014

(51) Int. Cl. G10L 13/08; G06N 3/02

(52) U.S. Cl. CPC G10L 13/08; G06N 3/02

(57) ABSTRACT

The technology relates to performing letter-to-sound conversion utilizing recurrent neural networks (RNNs). The RNNs may be implemented as RNN modules for letter-to-sound conversion. The RNN modules receive text input and convert the text to corresponding phonemes. In determining the corresponding phonemes, the RNN modules may analyze the letters of the text and the letters surrounding the text being analyzed. The RNN modules may also analyze the letters of the text in reverse order. The RNN modules may also receive contextual information about the input text. The letter-to-sound conversion may then also be based on the contextual information that is received. The determined phonemes may be utilized to generate synthesized speech from the input text.

### BACKGROUND

Text-to-speech applications are utilized to read written text aloud. Such applications may assist people with poor eyesight, people who are in a position where reading the text is undesired, such as driving in a car, and people who may just prefer to hear text read aloud rather than having to read the text. In situations where text is read aloud to the user, the user often wants to hear a voice that sounds more natural and accurately reads the text.

One aspect of text-to-speech conversion is letter-to-sound (LTS) conversion. LTS conversion is useful for determining the pronunciation of all words, but it may be especially useful for words that are out of vocabulary, or not otherwise known. Prior attempts at LTS conversion, however, result in spoken audio that is often difficult to understand or unpleasant for the user to hear.

It is with respect to these and other general considerations that embodiments have been made. Also, although relatively specific problems have been discussed, it should be understood that the embodiments should not be limited to solving the specific problems identified in the background.

### SUMMARY

In one aspect, the technology relates to a method for converting text to speech. The method includes receiving text input, wherein the text input is in the form of letters. The method further includes determining phonemes from the text input, wherein determining the phonemes from the text input utilizes a recurrent neural network. The text input is input to both a hidden layer and an output layer of the recurrent neural network. The method also includes outputting the determined phonemes. In one embodiment, the method also includes generating a generation sequence. In another embodiment, the method also includes synthesizing the generation sequence to create synthesized speech. In yet another embodiment, the method also includes receiving contextual information regarding the input text. In still another embodiment, the contextual information is received as a dense auxiliary input.

In another embodiment, the dense auxiliary input is input into the hidden layer and the output layer of the recurrent neural network. In yet another embodiment, determining the phonemes is further based on the contextual information. In still another embodiment, the text input and the contextual information are received as a dense auxiliary input.

In another embodiment, determining the phonemes includes analyzing the input text in reverse order. In yet another embodiment, determining the phonemes comprises analyzing letters before and after the input text.

In another aspect, the technology relates to a computer storage device, having computer-executable instructions that, when executed by at least one processor, perform a method for converting text to speech. The method includes receiving text input, wherein the text input is in the form of letters. The method further includes determining phonemes from the text input, wherein determining the phonemes from the text input utilizes a recurrent neural network. The text input is input to both a hidden layer and an output layer of the recurrent neural network. The method also includes outputting the determined phonemes. In one embodiment, the method also includes generating a generation sequence. In another embodiment, the method also includes synthesizing the generation sequence to create synthesized speech. In yet another embodiment, the method also includes receiving contextual information regarding the input text. In still another embodiment, the contextual information is received as a dense auxiliary input.

In another embodiment, determining the phonemes is further based on the contextual information. In yet another embodiment, the text input and the contextual information are received as a dense auxiliary input. In still another embodiment, determining the phonemes includes analyzing the input text in reverse order. In another embodiment, determining the phonemes includes analyzing letters before and after the input text.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive embodiments are described with reference to the following Figures.

FIG. 1 illustrates a system for converting text to speech, according to an example embodiment.

FIG. 2 depicts an architecture of an RNN suitable for use in the LTS RNN module, according to an example embodiment.

FIG. 3 depicts another architecture of an RNN suitable for use in the LTS RNN module, according to an example embodiment.

FIG. 4 depicts another architecture of an RNN suitable for use in the LTS RNN module, according to an example embodiment.

FIG. 5 depicts another architecture of an RNN, according to an example embodiment.

FIG. 6 depicts a method for determining the part-of-speech for text utilizing an RNN, according to an example embodiment.

FIG. 7 is a block diagram illustrating example physical components of a computing device with which embodiments of the disclosure may be practiced.

FIGS. 8A and 8B are simplified block diagrams of a mobile computing device with which embodiments of the present disclosure may be practiced.

FIG. 9 is a simplified block diagram of a distributed computing system in which embodiments of the present disclosure may be practiced.

FIG. 10 illustrates a tablet computing device for executing one or more embodiments of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

The present disclosure generally relates to converting text to speech. Conventionally, text-to-speech applications are performed by using methods based on look-up-tables and decision trees, such as Classification and Regression Trees (CART). These prior methods, however, suffer from many disadvantages. For example, CART based text-to-speech often has difficulty determining pronunciations, and the conventional text-to-speech methods lack context awareness when converting the text-to-speech. Additionally, the prior methods, such as cascading tagger modules, accumulate errors as they cascade. Further, with the prior methods, including additional context or feature information would have resulted in large increases in computing costs.

To improve text-to-speech applications, recurrent neural networks (RNN) may be utilized. RNNs have the benefit of being able to handle additional features and side information without data fragmentation. The RNNs also provide better performance at the same time. In embodiments, an RNN module may be used to determine phonemes from letters of words, as a part of letter-to-sound (LTS) conversion. LTS conversion is useful for determining the pronunciation of all words, but it may be especially useful for words that are out of vocabulary, or not otherwise known. The LTS conversion with an RNN module may also enhance pronunciation with syllable stress levels. By using an RNN module for LTS, phonemes may be determined for text by analyzing the text itself and the text surrounding the text that it is analyzed. The phonemes may also be determined in part based on contextual or semantic information regarding the text being analyzed.

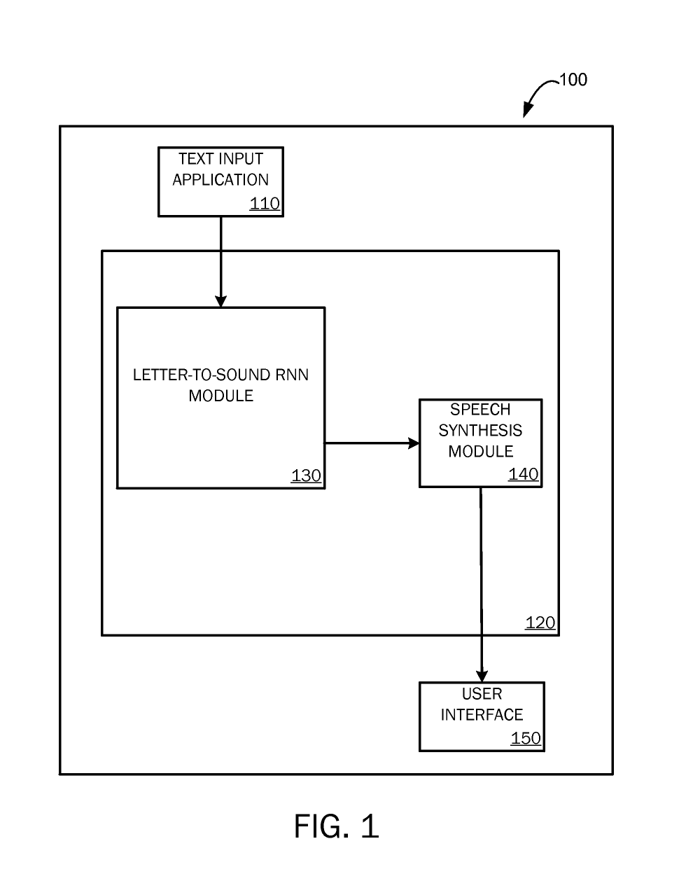

FIG. 1 depicts a system 100 for converting text to speech. The system 100 may be a part of a device having text-to-speech capabilities, such as a mobile telephone, a smart phone, a wearable computer (such as a smart watch or other wearable devices), a tablet computer, a laptop computer, and the like. In some embodiments, the computer system 100 includes a text input application 110, a text-to-speech module 120, and a user interface 160. The text input application 110 may include any application suitable for providing text to the text-to-speech module 120. For example, the text input application 110 may include a word processing application or other productivity applications. Other applications may include communication applications such as e-mail applications or text messaging applications. Text input application 110 may also be a database containing text that the application 110 is able to provide to the text-to-speech module 120. The text input application 110 may also facilitate the transfer of text from other applications or text sources to the text-to-speech module 120.

The user interface 150 may be any user interface suitable for facilitating interaction between a user and an operating environment of a computer system. For example, the user interface 150 may facilitate audibly presenting synthesized speech through a sound output mechanism, such as a speaker. The user interface 160 may also facilitate the input of text to be converted to speech.

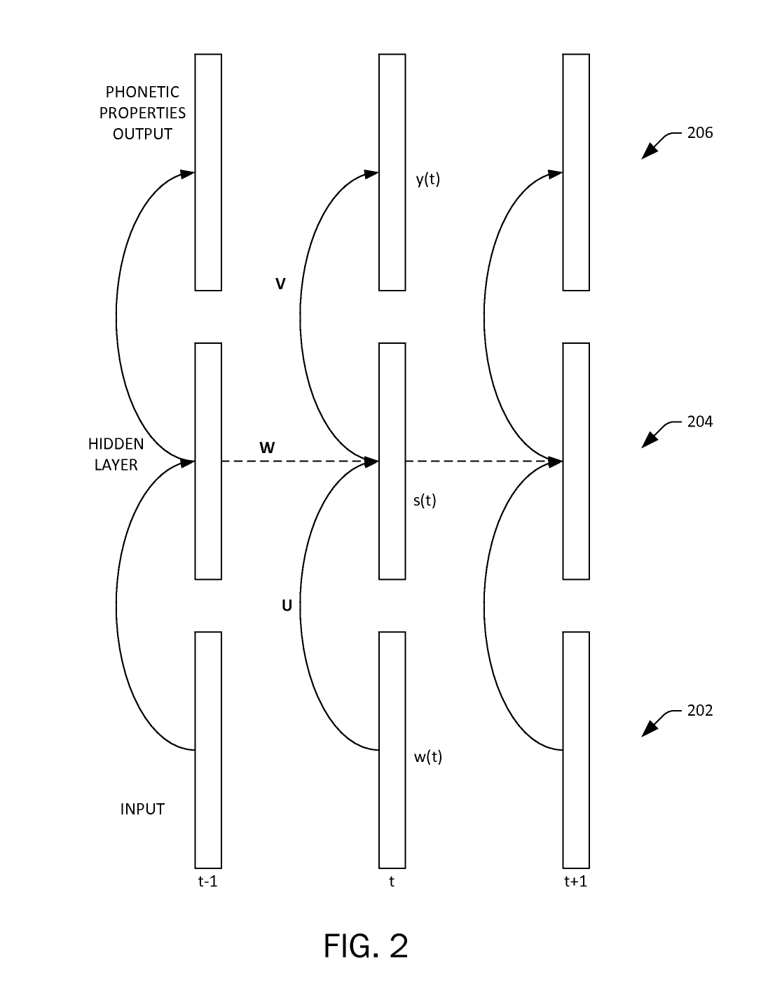

The text-to-speech module 120 may be part of an operating environment of the computer system 100. For example, text-to-speech module 120 is configured to analyze text to convert it to audible speech. In this regard, in embodiments, the text-to-speech module 120 includes a letter-to-sound (LTS) RNN module 130 and a speech synthesis module 140. The LTS RNN module 130 converts letters to phonemes through the use of an RNN. One of the benefits of utilizing an LTS RNN module 130 is to more accurately determine pronunciations for words that are uncommon or not in a vocabulary of words known by the system. In some embodiments, the LTS RNN module 130 may include one or more additional modules for converting letters-to-sound. For example, one module may be for a particular language, while another module may be for another language. In some embodiments, a single multi-lingual module may be implemented as LTS RNN module 130. The LTS RNN module 130 receives input as multiple letters, such as the letters that form a word. The LTS RNN module 130 processes the input letters to determine the phonemes for the letters and words. In other words, the LTS RNN module 130 converts the letters to corresponding phonemes that can then be synthesized into audible speech. For example, in an embodiment, the letters in the word “activesync” may be converting to phonemes “ael k t ih v s ihl ng k”. The architecture of the LTS RNN module 130 is discussed in further detail with reference to FIGS. 2-4.

The LTS RNN module 130 may also provide an output suitable for synthesis to speech by the speech synthesis module 140. The speech synthesis module 140 receives the output from the LTS RNN module 130. The speech synthesis module 140 then synthesizes the output into speech. The speech synthesis may include converting the output from the speech synthesis module 140 to a waveform or similar format that can be utilized by the user interface 150 to create sound in the form of audible speech corresponding to the input text to the LTS RNN module 130.

The phoneme for each letter or grouping of letters is determined from the trained LTS RNN module 130 that processes an individual letter itself as well as the letters around the individual letter, such as the letters in front of the target letter and the letters behind the target letter. In some embodiments, only the letters in front of the target letter may be analyzed, and in other embodiments, only the letters behind the target word may be analyzed. The input may be in the form of words, such that the analysis is capable of determining how the letters around the target letter affect pronunciation. A reverse-back modeling may be used where the letters of the word are analyzed in reverse order. A more detailed description of RNN structures is discussed below with reference to FIGS. 2-4.

FIG. 2 depicts an architecture of an RNN that may be utilized in the LTS RNN module 130. An exemplary architecture of the RNN is shown in FIG. 2. In the architecture set forth in FIG. 2, the RNN is shown as being “unrolled” across time to cover three consecutive word inputs. The RNN comprises an input layer 202 at the “bottom” of the RNN, a hidden layer 204 in the middle with recurrent connections (shown as dashed lines), and an output layer 206 at the top of the RNN. Each layer represents a respective set of nodes, and the layers are connected with weights denoted by the matrices U, W, and V. For instance, in one embodiment, the hidden layer may contain 800 nodes. The input layer (vector) w(t) represents an input letter at time t encoded using 1-of-N coding (also called “one-hot coding”), and the output layer y(t) produces a probability distribution over phonemes that are assignable to the input text. The hidden layer 204 s(t) maintains a representation of the letter sequence history. The input vector w(t) has a dimensionality equal to the vocabulary size, and the output vector y(t) has a dimensionality equal to the number of possible assignable phonemes. The values in the hidden and output layers are computed as follows:

s(t)=f(Uw(t)+Ws(t−1)), (1)

y(t)=g(Vs(t)). (2)

where

$$f ( z ) = \frac{1}{1 + {e}^{- z}} , g ( {z}_{m} ) = \frac{{e}^{{z}_{m}}}{{\sum }_{k} {e}^{{z}_{k}}} . \qquad ( 3 )$$

The model can be trained using standard back propagation to maximize the data conditional likelihood, as follows:

ΠₜP(y(t)|w(1), . . . ,w(t)) (4)

Other training methods for RNNs may be utilized as well.

It can be noted that this model has no direct interdependence between output values. Rather, the probability distribution is a function of the hidden layer activations, which in turn depend on the word inputs (and their own past values). Further, a decision on y(t) can be made without reaching an end of the letter sequence (word). As such, the likeliest sequence of phonetic properties can be output with a series of decisions:

y*(t)=arg max P((y(t)|w(1) . . . (w(t)) (5)

This capability provides the further advantage of being able to be performed simply and online. In embodiments, it is unnecessary to do a dynamic programming search over phonemes to find the optimum.

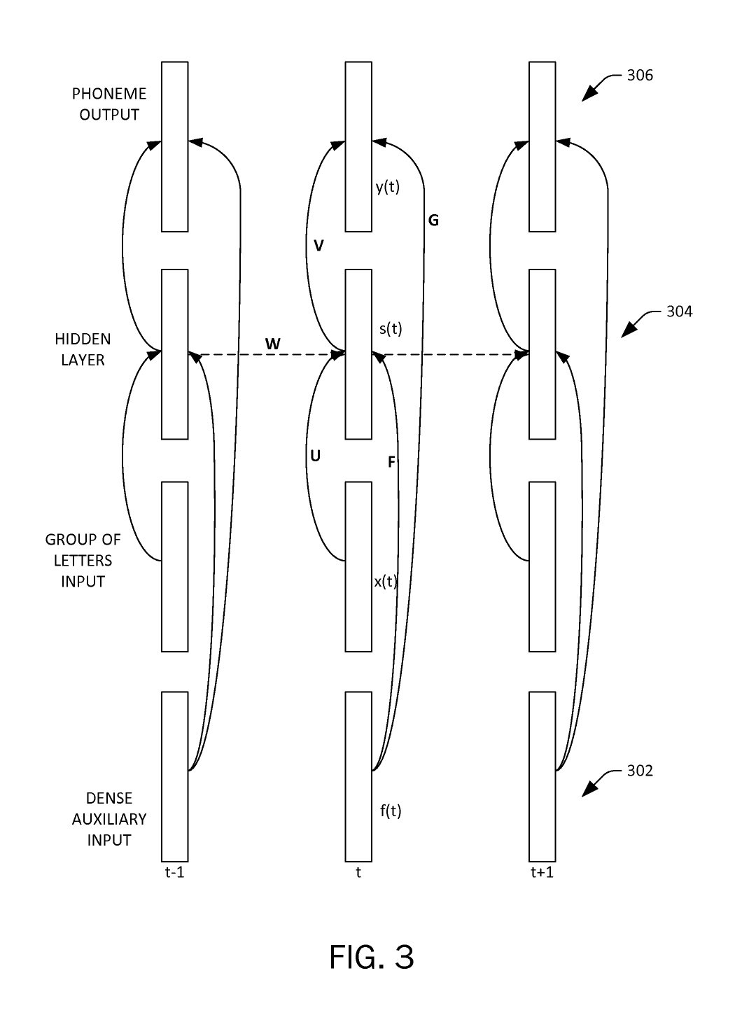

Another architecture of an RNN suitable for use in the LTS RNN module 130 is illustrated in FIG. 3. As it is desirable to identify a likeliest phoneme sequence for letters in the sequence of text given all letters in such sequence, “future” letters may be desirably employed as input when determining the semantic label for word w(t). Two exemplary approaches are described herein for doing so. First, the input layer of the RNN may be changed from a “one-hot” representation to an “n-hot” or group-of-letters representation, in which there is a non-zero value for not just the current letters, but the next n−1 letters as well. As such, future letters may be considered during the analysis. An advantage of this approach is using greater context, but a potential disadvantage is that ordering information may be lost.

The second exemplary approach for including future text is exemplified in the architecture shown in FIG. 3, which illustrates a “feature-augmented” architecture. In such approach, side information is provided by way of an extra layer 302 of dense (as opposed to “one-hot”) inputs f(t) with connection weights F to a hidden layer 304 and G to an output layer 306. Continuous space vector representations of future text may be provided as input to the hidden layer 304. In an exemplary embodiment, the representation of text may be learned by a non-augmented network (which may comprise weights from the input layer to the hidden layer). To retain text ordering information, representations may be concatenated in sequence in a given context window. Training and decoding procedures are otherwise unaltered.

In the architecture of FIG. 3, the activation computation can be modified as follows:

s(t)=f(Ux(t)+Ws(t−1)+Ff(t)), (6)

y(t)=g(Vs(t)+Gf(t)), (7)

where x(t) can be either w(t) or a group-of-letters vector. For instance, x(t)={w(t), w(t+1)} and comprises the current text and the next or future text, forming a “2-hot” representation.

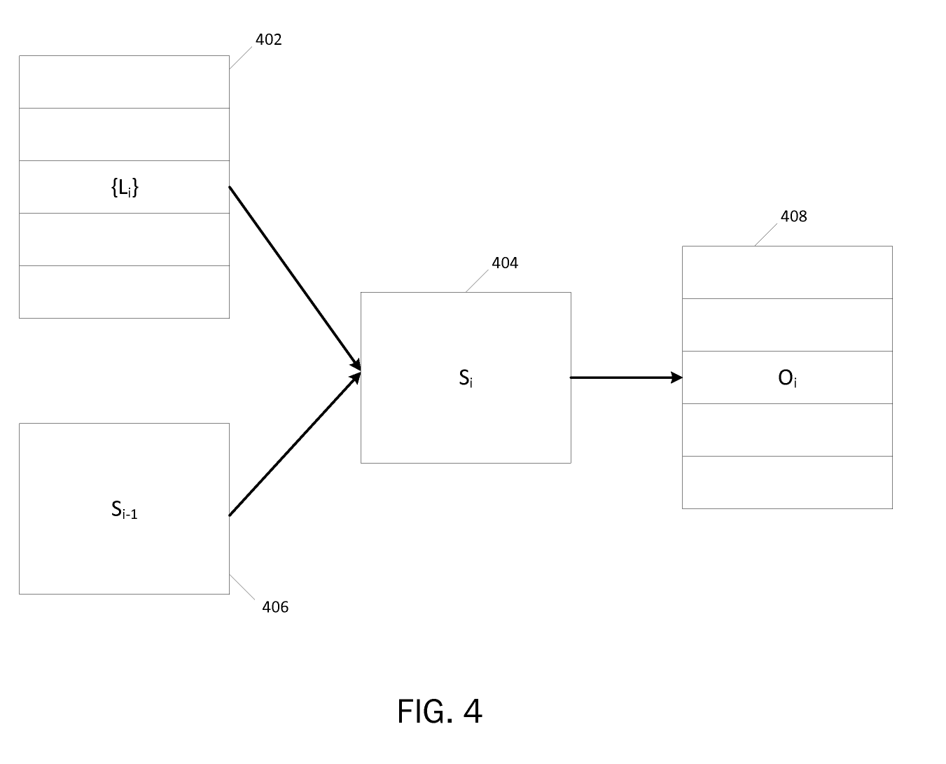

FIG. 4 illustrates another depiction of a high level architecture for an RNN suitable for use in the LTS RNN module 130. The input feature {L} 402 for the RNN includes the current letter {Lᵢ} and may include additional letters as indicated by the index i. The subscript i denotes the sequential index for the letter index in each word. The state S from the hidden layer 404 in the RNN architecture is used to record the history information for the letter sequence. The state S for the current index is then returned into the RNN for the next index in the sequence, as shown by the Sᵢ₋₁ input 406 and as discussed above with reference to FIGS. 2-3. Based on the inputs, the RNN determines an output 408 for each index letter of the input sequence.

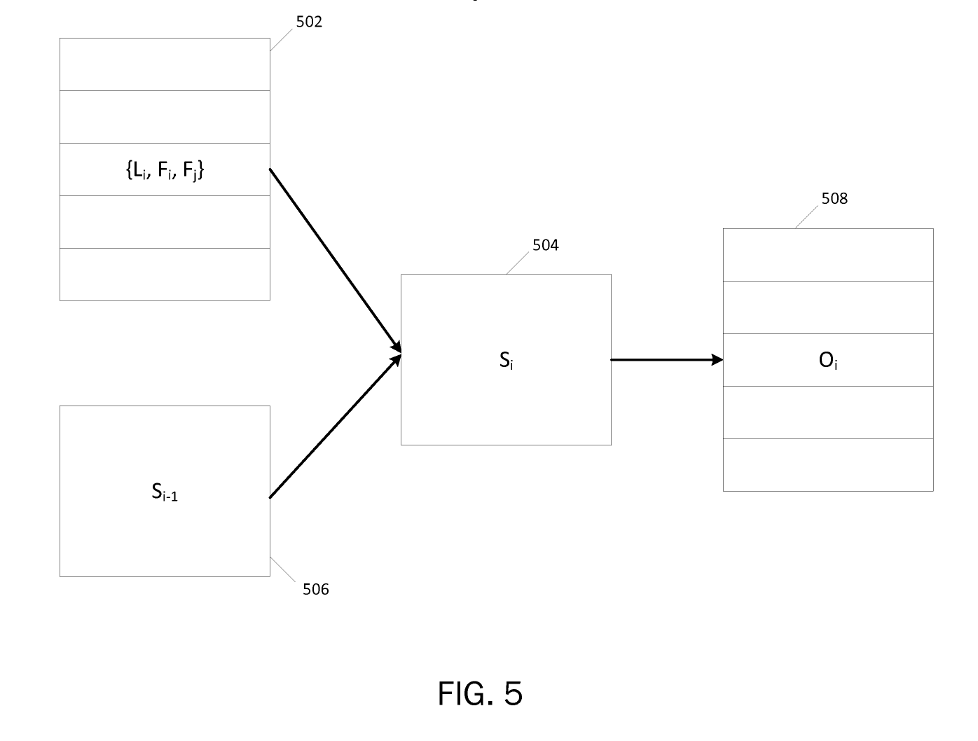

FIG. 5 illustrates another depiction of a high level architecture for an RNN suitable for use in the LTS RNN module 130. The input feature {Lᵢ, Fᵢ, Fⱼ} 502 for the RNN includes the current letter {L} and an auxiliary feature {F}, wherein the auxiliary feature may include additional information regarding the text, such as contextual information. The auxiliary feature {F} may include the current auxiliary feature on the same scale of the input, denoted as Fᵢ. The subscript i denotes the sequential index for the letter index in each word. The auxiliary feature {F} may also include higher scale auxiliary features, denoted as Fⱼ. The subscript j similarly denotes a higher scale sequential index than the current index. For example, on the letter scale RNN modeling for LTS, higher scale tags, such as word, sentence, and dialogue scale tags, may be utilized as auxiliary features Fⱼ. The state S from the hidden layer 504 in the RNN architecture is used to record the history information for the letter sequence. The state S for the current index is then returned into the RNN for the next index in the sequence, as shown by the Sᵢ₋₁ input 506 and as discussed above with reference to FIGS. 2-3. Based on the inputs, the RNN determines an output 508 for each index letter of the input sequence.

For the LTS RNN module 130, the input text into the RNN is in the form of letters in a word. Each index, i, in the sequence denotes an individual letter in a word. The output from the LTS RNN module 106 is a sequence of phonemes for the letters of the words. The auxiliary features for the LTS RNN module 106 may include features indicating the context of the letters or the words formed by the letters. In some embodiments, the auxiliary features are on the same scale as the letters or on a higher scale, such as the word, sentence, or dialogue scale.

For example, for the word “hot,” the letter “h” may be considered L₀. The letter “o” would be L₁, and “t” would be L₂. In that example, the letter “h” is processed in the hidden layer and the encoded history of that processing is represented as S₀. Based on the processing, the output of the phoneme corresponding to “h” is output as O₀. The processing of the letter “h” may also be based on the future letters, “o” and “t”. The future letters may be input into the RNN as part of a feature vector. The letter “o”, input as L₁, is processed in the hidden layer and the encoded history of that processing is represented as S₁. The processing may be based on the history of the letters previously analyzed, encoded as S₀, and the future letters. By analyzing the future letters in determining the phoneme for the letter “o”, it can be determined that the letter “o” in the word “hot” should be assigned a phoneme corresponding to the short o sound, rather than the long o sound, as in the word “hole.” Based on that processing, an output of the phoneme corresponding to “o” is output as O₁. The final letter in the word, “t”, then processed. The history of the letters in the word is encoded as S₁, and an output of the phoneme is corresponding to the letter “t” is output as O₂. The amount of history encoded in S may be adjusted to limit the number of prior letters that may be taken into consideration. The number of future letters considered may also be limited to a predetermined number of future letters.

The LTS RNN module may also perform reverse-back analysis to process the letters in a word in a reverse order. In other words, the letters in the suffix are analyzed prior to the letters in the root of the word or in the prefix of the word. Using the above example, for the word “hot,” the letter “h” may be considered L₀, the letter “o” would be L₁, and “h” would be L₂. By performing the reverse analysis, the phoneme output of the above example may be confirmed. The reverse analysis may also be used as a primary analysis to produce phonemes corresponding to the letters of the words.

For some languages, the reverse-back analysis may provide more accurate results than the prior methods, such as using a CART-tree decision analysis. The following table summarizes results from an experiment testing the RNN technology against a baseline of a CART-tree analysis. The experiment was with same-letter phonemes by the unified evaluation script on en-US (with stress) setup. The training set was 195,080 words, the test set was 21,678 words, and the results were based on natural phoneme sequences (no compound phonemes or empty phonemes).

| | | Phoneme |
|---|---|---|
| LTS Process | Word Error Rate | Error Rate |
| Baseline (CART Tree) | 44.15% | 8.36% |
| RNN (Reverse-Back, 700 hidden state) | 42.26% | 7.09% |

From the results, the RNN process provides a 4.28% relative improvement over the word error rate, and a 15.19% relative improvement over the phoneme error rate.

Context may also be taken into account to determine the proper phoneme sequence as output. For example, consider the word “read.” The phoneme sequence for the word “read” may be different depending on the context in which it is used. The word “read” is pronounced differently in the sentence “The address file could not be read,” than it is in the sentence “The database may be marked as read-only.” As another example, the word “live” similarly has different pronunciations based on the context in which it is used. The word “live” is pronounced differently in the sentence “The UK's home of live news” than it is in the sentence “My name is Mary and I live in New York.” The contextual information may be input into the RNN structure as a dense auxiliary input {F} or as a part of a dense auxiliary input {F}. For example, in the latter example, the contextual information in the first sentence may be that the word “live” is an adjective, whereas in the second sentence the word “live” is a verb. This contextual information may be determined prior to determining the phonemes of the text. In some embodiments, the contextual information is determined by another RNN module. In other embodiments, the contextual information is assigned to the text utilizing other tagging methods, such as CART-based decision trees and the like.

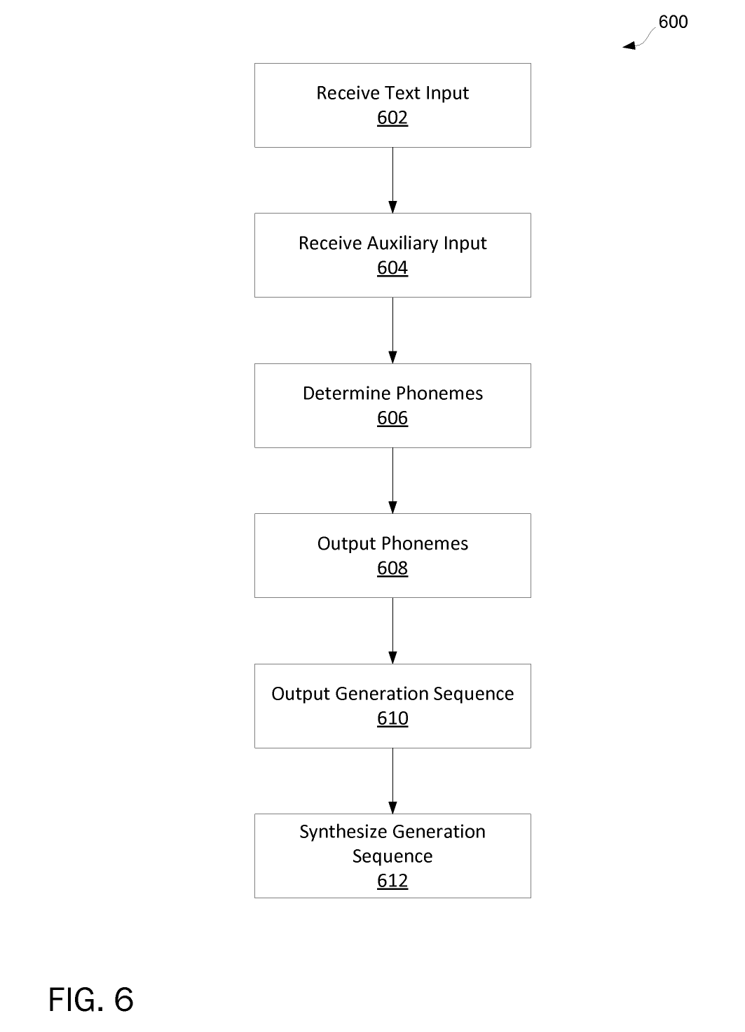

FIG. 6 illustrates a methodology relating to converting text to speech. While the methodology is shown and described as being a series of acts that are performed in a sequence, it is to be understood and appreciated that the methodology is not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodology can be stored in a computer-readable medium, displayed on a display device, and/or the like.

FIG. 6 depicts a method 600 for determining phonemes for text utilizing an RNN. At operation 602, text input is received. The text input may be received in the form of letters in a word. The letters may also be received as a group-of-text representation. At operation 604, auxiliary input is received. The auxiliary information may include contextual and/or semantic information about the input text. The auxiliary information may also include the current text and the future text. In such embodiments where all the input text is included as a dense auxiliary input, the separate text input at operation 602 may be unnecessary.

At operation 606, letter-to-sound phonetic properties, such as phonemes, for the text is determined utilizing an RNN. For example, the LTS RNN module 130 may determine the phonemes for the text, as discussed above. In some embodiments, determining the phonemes for text includes analyzing the text in a reverse order. In other embodiments, determining the phonemes includes analyzing letters around a particular letter to determine the corresponding phonemes. At operation 608, the determined phonemes are outputted. In some embodiments, the outputted phonemes are in the form of a generation sequence that can be synthesized into speech. In other embodiments, the phonemes are further utilized to generate a generation sequence at operation 610. The generation sequence is a set of data that may be utilized by a speech synthesizer, such as speech synthesis module 140, to synthesize speech at operation 612. This may include developing a waveform that may be input to a speaker to create audible speech. Those having skill in the art will recognize additional methods for speech synthesis from a generation sequence.

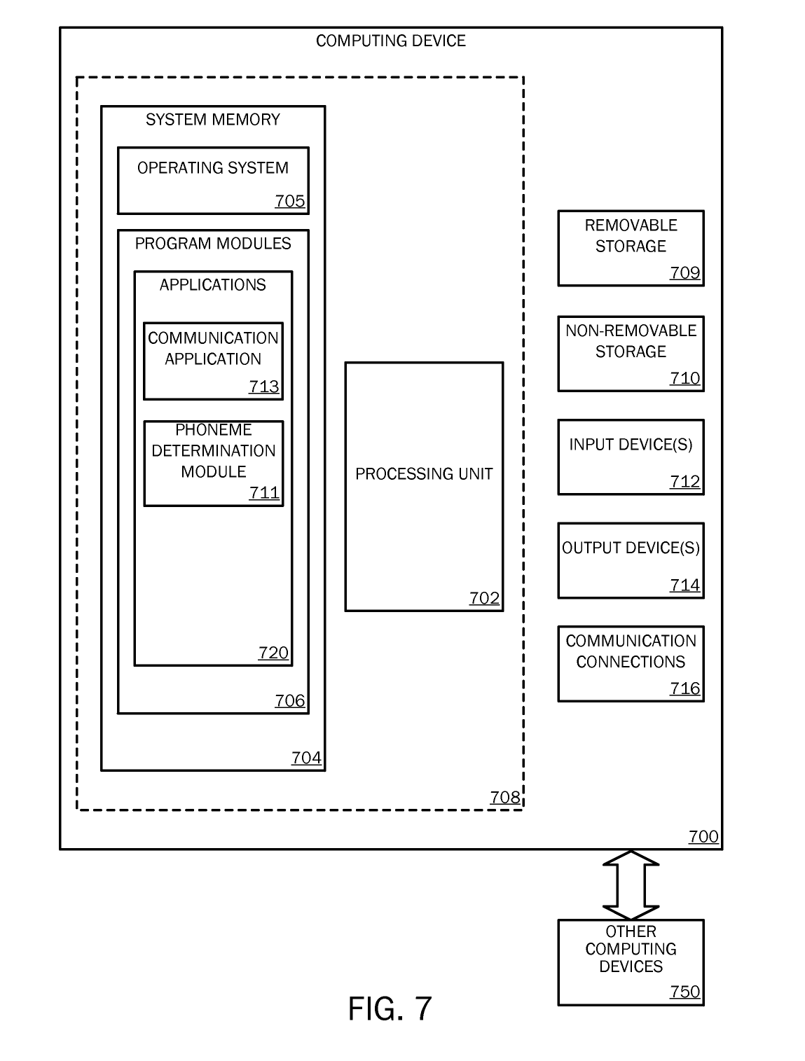

FIG. 7 is a block diagram illustrating physical components (e.g., hardware) of a computing device 700 with which embodiments of the disclosure may be practiced. The computing device components described below may have computer executable instructions for a communication application 713, e.g., of a client and/or computer executable instructions for phoneme determination module 711, e.g., of a client, that can be executed to employ the methods disclosed herein. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for running software applications 720 such as determining and assigning phonetic properties as discussed with regard to FIGS. 1-10 and, in particular, communication application 713 or phoneme determination module 711. The operating system 705, for example, may be suitable for controlling the operation of the computing device 700. Furthermore, embodiments of the disclosure may be practiced in conjunction with a graphics library, audio library, speech database, speech synthesis applications, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., phoneme determination module 711 or communication application 713) may perform processes including, but not limited to, the embodiment, as described herein. Other program modules that may be used in accordance with embodiments of the present disclosure, and in particular to generate screen content and audio content, may include electronic mail and contacts applications, word processing applications, spreadsheet applications, database applications, slide presentation applications, drawing, messaging applications, mapping applications, text-to-speech applications, and/or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 718. Examples of suitable communication connections 716 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

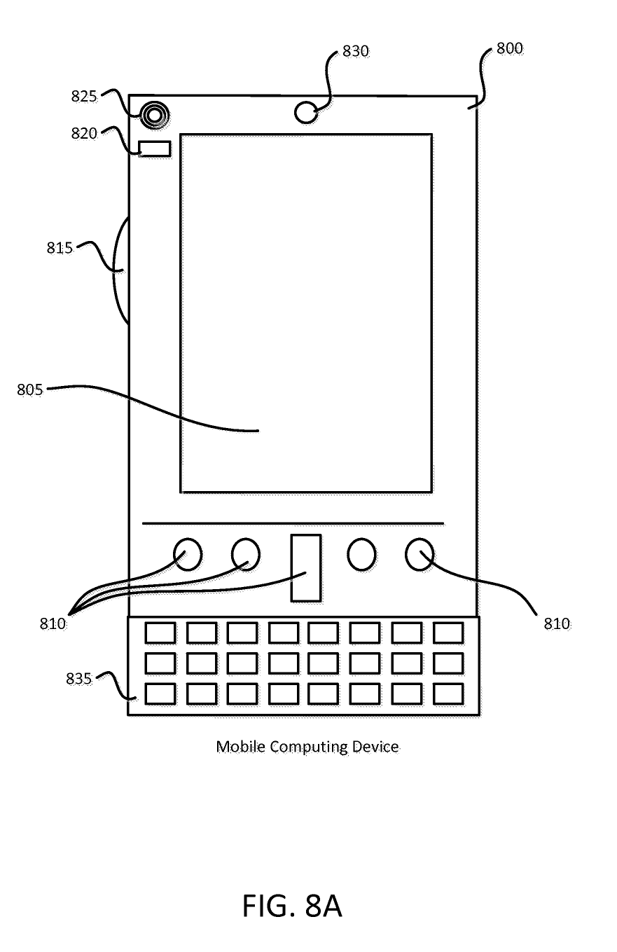

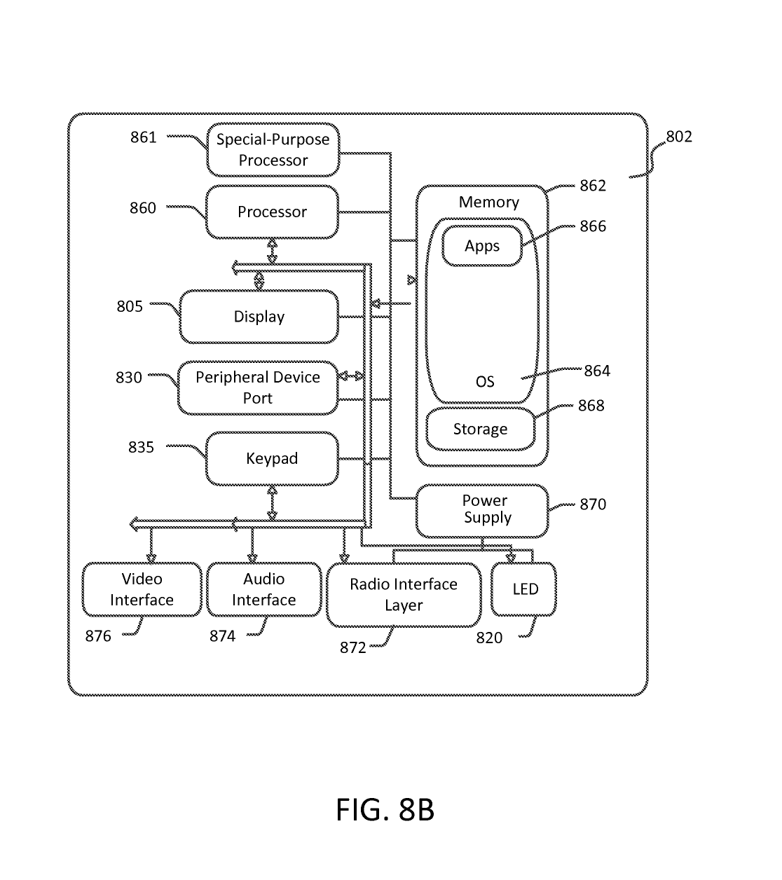

FIGS. 8A and 8B illustrate a mobile computing device 800, for example, a mobile telephone, a smart phone, wearable computer (such as a smart watch), a tablet computer, a laptop computer, and the like, with which embodiments of the disclosure may be practiced. In some embodiments, the client may be a mobile computing device. With reference to FIG. 8A, one embodiment of a mobile computing device 800 for implementing the embodiments is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative embodiments, mobile computing device 800 may incorporate more or less input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In some embodiments, the mobile computing device 800 incorporates a vibration transducer for providing the user with tactile feedback. In yet another embodiment, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one embodiment of a mobile computing device. That is, the mobile computing device 800 can incorporate a system (e.g., an architecture) 802 to implement some embodiments. In one embodiment, the system 802 is implemented as a “smart phone” capable of running one or more applications (e.g., browser, e-mail, calendaring, contact managers, messaging clients, games, text-to-speech applications, and media clients/players). In some embodiments, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, text-to-speech applications, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800, including the instructions to determine and assign phonetic properties as described herein (e.g., and/or optionally phoneme determination module 711).

The system 802 has a power supply 870, which may be implemented as one or more batteries. The power supply 870 might further include an external power source, such as an AC adapter or a powered docking cradle that supplements or recharges the batteries.

The system 802 may also include a radio 872 that performs the function of transmitting and receiving radio frequency communications. The radio 872 facilitates wireless connectivity between the system 802 and the “outside world,” via a communications carrier or service provider. Transmissions to and from the radio 872 are conducted under control of the operating system 864. In other words, communications received by the radio 872 may be disseminated to the application programs 866 via the operating system 864, and vice versa.

The visual indicator 820 may be used to provide visual notifications, and/or an audio interface 874 may be used for producing audible notifications via the audio transducer 825. In the illustrated embodiment, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with embodiments of the present disclosure, the microphone may also serve as an audio sensor to facilitate control of notifications, as will be described below. The system 802 may further include a video interface 876 that enables an operation of an on-board camera 830 to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio 872 or via a distributed computing network. Similarly, such data/information may be readily transferred between computing devices for storage and use according to well-known data/information transfer and storage means, including electronic mail and collaborative data/information sharing systems.

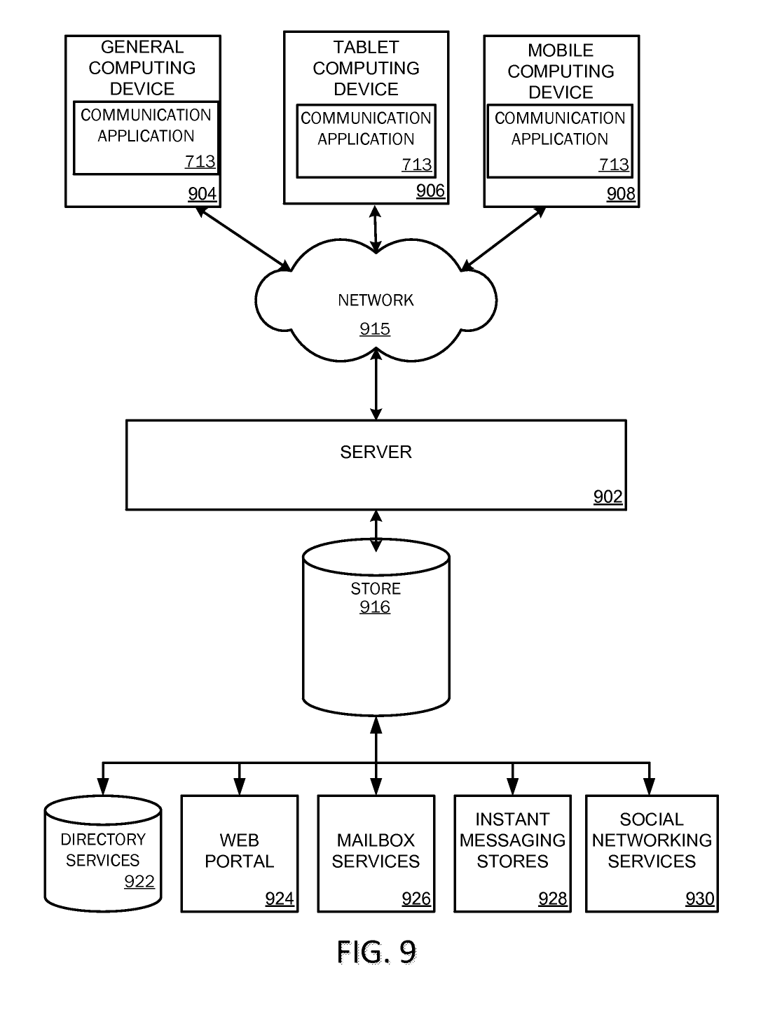

FIG. 9 illustrates one embodiment of the architecture of a system for processing data received at a computing system from a remote source, such as a computing device 904, tablet 906, or mobile device 908, as described above. Content displayed at server device 902 may be stored in different communication channels or other storage types. For example, various documents may be stored using a directory service 922, a web portal 924, a mailbox service 926, an instant messaging store 928, or a social networking site 930. The communication application 713 may be employed by a client who communicates with server 902. The server 902 may provide data to and from a client computing device such as a personal computer 904, a tablet computing device 906 and/or a mobile computing device 908 (e.g., a smart phone) through a network 915. By way of example, the computer system described above with respect to FIGS. 1-5 may be embodied in a personal computer 904, a tablet computing device 906 and/or a mobile computing device 908 (e.g., a smart phone). Any of these embodiments of the computing devices may obtain content from the store 916, in addition to receiving graphical data useable to be either pre-processed at a graphic-originating system, or post-processed at a receiving computing system.

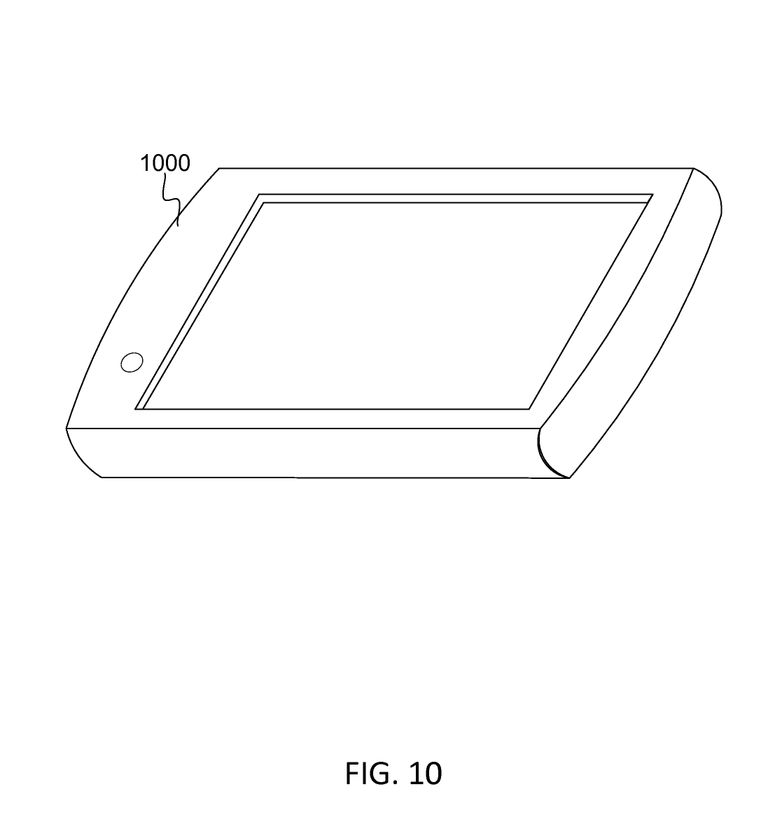

FIG. 10 illustrates an exemplary tablet computing device 1000 that may execute one or more embodiments disclosed herein. In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the disclosure as claimed in any way. The embodiments, examples, and details provided in this application are considered sufficient to convey possession and enable others to make and use the best mode of claimed disclosure. The claimed disclosure should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed disclosure.

1. A method for converting text to speech, the method comprising:
receiving text input, wherein the text input is in the form of letters;
determining phonemes from the text input, wherein determining the phonemes from the text input utilizes a recurrent neural network, wherein the text input is input to both a hidden layer and an output layer of the recurrent neural network; and
outputting the determined phonemes.

2. The method of claim 1, further comprising generating a generation sequence.

3. The method of claim 2, further comprising synthesizing the generation sequence to create synthesized speech.

4. The method of claim 1, further comprising receiving contextual information regarding the input text.

5. The method of claim 4, wherein the contextual information is received as a dense auxiliary input.

6. The method of claim 5, wherein the dense auxiliary input is input into the hidden layer and the output layer of the recurrent neural network.

7. The method of claim 4, wherein determining the phonemes is further based on the contextual information.

8. The method of claim 4, wherein the text input and the contextual information are received as a dense auxiliary input.

9. The method of claim 1, wherein determining the phonemes comprises analyzing the input text in reverse order.

10. The method of claim 1, wherein determining the phonemes comprises analyzing letters before and after the input text.

11. A computer storage device, having computer-executable instructions that, when executed by at least one processor, perform a method for converting text-to-speech, the method comprising:
receiving text input, wherein the text input is in the form of letters;
determining phonemes from the text input, wherein determining the phonemes from the text input utilizes a recurrent neural network, wherein the text input is input to both a hidden layer and an output layer of the recurrent neural network; and
outputting the determined phonemes.

12. The method of claim 11, further comprising generating a generation sequence.

13. The method of claim 12, further comprising synthesizing the generation sequence to create synthesized speech.

14. The method of claim 11, further comprising receiving contextual information regarding the input text.

15. The method of claim 14, wherein the contextual information is received as a dense auxiliary input.

16. The method of claim 14, wherein determining the phonemes is further based on the contextual information.

17. The method of claim 14, wherein the text input and the contextual information are received as a dense auxiliary input.

18. The method of claim 11, wherein determining the phonemes comprises analyzing the input text in reverse order.

19. The method of claim 11, wherein determining the phonemes comprises analyzing letters before and after the input text.

20. A system for converting text-to-speech comprising:
at least one processor; and
memory encoding computer executable instructions that, when executed by at least one processor, perform a method for converting text-to-speech, the method comprising:
receiving text input, wherein the text input is in the form of letters;
determining phonemes from the text input, wherein determining the phonemes from the text input utilizes a recurrent neural network, wherein the text input is input to both a hidden layer and an output layer of the recurrent neural network; and
outputting the determined phonemes.
